(19) United States
(12) Patent Application Publication
(10) Pub. No.: US 2005/0082838 A1
(43) Pub. Date: Apr. 21, 2005

(54) Coupled flux rotator

(76) Inventor: Daniel Collins, Sydney (AU)

Correspondence Address: Dan Collins, PSC 76 Box 3205, APO, AP, 96319-0011, US

(21) Appl. No.: 10/687,538

(22) Filed: Oct. 17, 2003

(51) Int. Cl. F03D 9/00; H02P 9/04

(52) U.S. Cl. 290/55

(57) ABSTRACT

Presented is a design for a High-Torque, Low Speed, Vertical_Axis, Flux Rotator, designed primarily to function in a low velocity, uniform, homotropic flow with the axis of rotation vertical to the flow and co-incident to the gradient of the gravitational field. It follows from Australian Commonwealth Government Patent 2112100575, The Flux Rotator. The design modifications are intended to help the stationary turbine start in a very slow velocity fluid without a ‘kick-start’ and improve performances at those lower speeds. For measurement and energy transfer applications the new design will work in a wide variety of liquids and gasses, in a wide range of fluid viscosity's and temperatures.

This patent claims priority from an Australian Commonwealth patent (2002) Coupled flux rotator by the same inventor.

This device uses an inventive step to obtain an improved Flux rotator (Australian Commonwealth Patent 2002100575).

### BACKGROUND TO THE INVENTION

The vertical-axis wind generator has a long history, a few types have been in existence or known before there was a patent office or academic journals anywhere in the world, so are known generically by a modern proponent or popularizer of the type. The commonly known Savonius (U.S. Pat. No. 1,697,574, 1929) type of vertical axis wind generator is conceptually congruent to the popular cup anemometer, a device commonly used to measure wind speed. These are typically three or four cup devices, approximately hemispherical cups, which approaching the wind with the axis of rotational symmetry co-incident to the fluid velocity vector (convex side forward), present less drag than the force on the opposite cup which catches the wind and so generates a torque about the axis of rotation.

Savonius built several larger devices with not hemispherical cups but vanes semi-circular in section. The general difficulty with the Savonius type is that they tend to be slow, about 30˜40 r.p.m, and being of relatively short radius of vane have neither high speed or high torque, giving them no great power, and therefore are not particularly cost effective. Making radially longer vanes gives more torque, but on the return leg against the wind, the velocity of the tip is proportional to the radius, and since the Bernoulli drag is proportional to the square of the velocity, here twice the wind speed (assuming the tip speed is the wind speed), the drag increases until it equals the torque about the axis, giving little or no power.

Attempts have been made to ameliorate the drag effect by numerous inventors (Davishian, U.S. Pat. No. 4,015,911, Yengst, U.S. Pat. No. 3,942,909).

The Savonius idea has been widely used however in wind powered exhaust fans on ventilation shafts in tall buildings, or as fans to ventilate roof cavities in hot climates.

Another well-known vertical axis wind generator is the Darrieus (eggbeater) type, Patented 1927, which seems to have had brilliant but short career in the wind generator industry. (Since the last company that manufactured this type in large scale in California, Flowind, went bankrupt in 1997).

At any rate this type of vertical axis wind turbine is quite different in concept to the Flux Rotator which is a drag device, not employing lift explicitly, and therefore won't be discussed here.

The vertical axis machine the Flux Rotator is most similar to is the generically known Panemone device, known from at least the 12^{th} century. The general idea is to have a drag type device where a blade catches the wind on the down wind leg and on the return trip flips back to present its edge to the wind, or as a sail collapses, and presents less drag.

There have been countless implementations of this idea in history, and there are a considerable number of patents of similar devices recorded, with additions of braking devices, linkages, safety measures to prevent overspeeding.

A large number of the devices recorded, that the author has examined, continue the idea that the semi rigid vane be hinged on a vertical axis.

The vast majority of Panemone type devices recorded have blades whose vertical height is larger than their horizontal width, irrespective of the machines operating radius. Generally speaking they are configured similarly to a Savonius machine, to prefer a higher r.p.m. to a higher torque, so having a smaller radius than their height. It is apparent that making a Panemone type machine with blades hinging on a vertical axis cannot be made with blades of great radial length, because of the danger of unbalancing the machine and the large centrifugal forces. So ultimately the Panemone machine has the same draw backs as the Savonius rotor, it has a relatively small torque and relatively low r.p.m. giving, again, no great power.

So one can frame a general rule that a vertical-axis turbine employing drag as its motive force (not lift) to be effective must have a high torque, therefore it must have a wide radius, since its top speed of the blade tip is approximately the wind speed and its r.p.m. quite limited. This rule excludes the Savonius and Panemone types from the desirable group of machines.

There have been occasional inventors who have grasped this principle and have attempted to design vertical axis machines with large radii with blades on the upwind journey feathered or collapsible by some means, often requiring a rudder to orient the device to face the wind. There have been some omni directional devices designed, which are mechanically quite complex, with, springs, cables, weights, cams, pulleys, pistons, and etc.

A notable attempt is that of Rhodes, (U.S. Pat. No. 5,083,902, 1992), and I refer the reader to his quite informative discussion of past inventions (see his patent documents). I will not explicitly discuss these ideas myself because, I feel that the Flux Rotator and following devices were invented in ignorance of the “prior art” and that by its minimal simplicity and efficiency, owes nothing to more complicated, sophisticated arrangements. In fact the invention of the Flux Rotator “cuts the Gordian knot” of complexity and makes the widespread use of a simple effective, affordable vertical axis wind turbine possible.

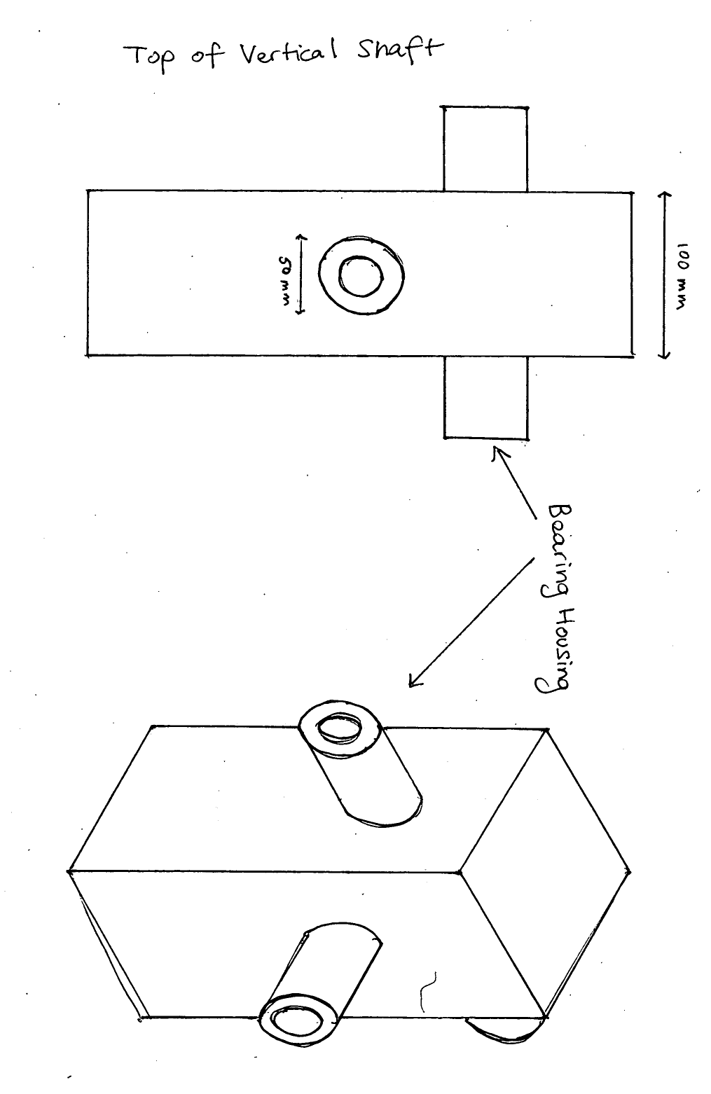

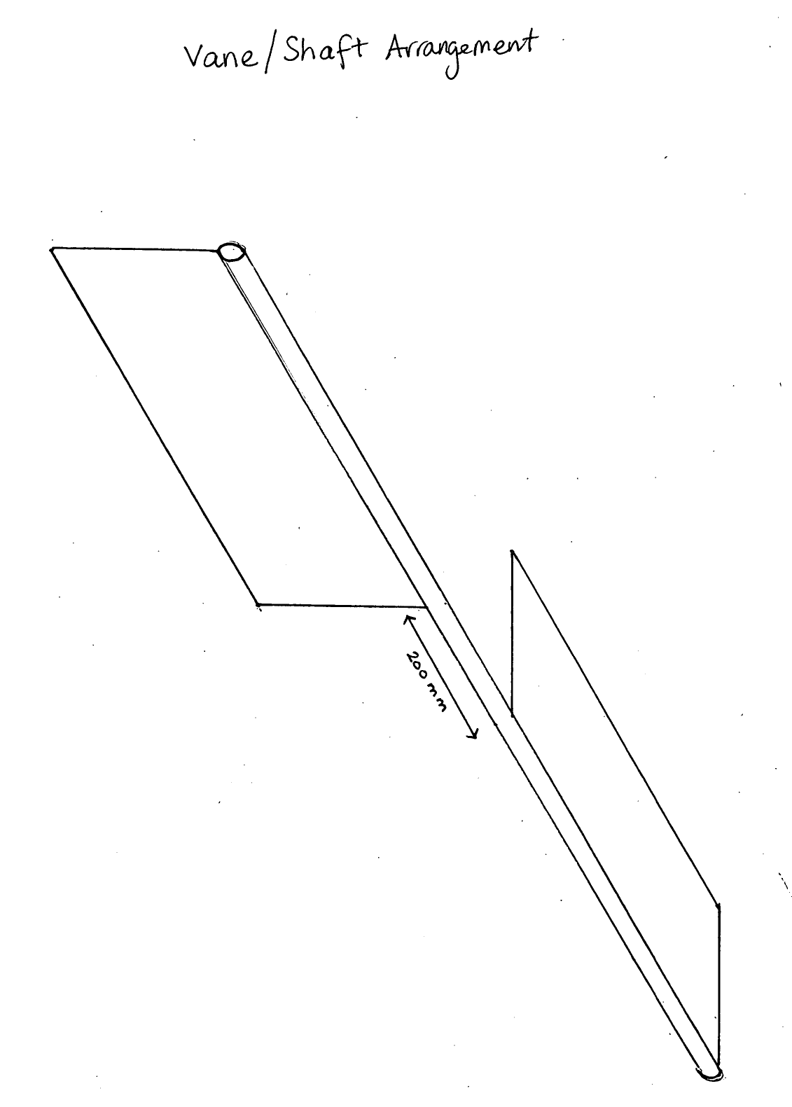

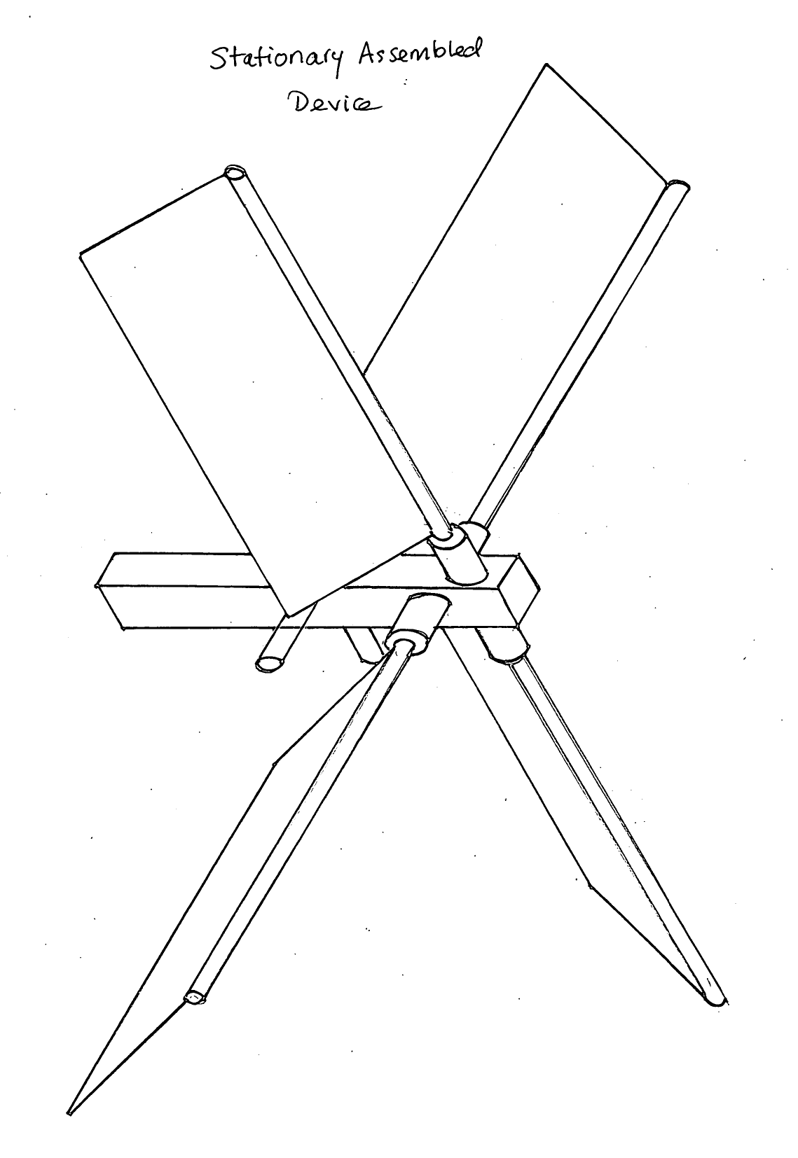

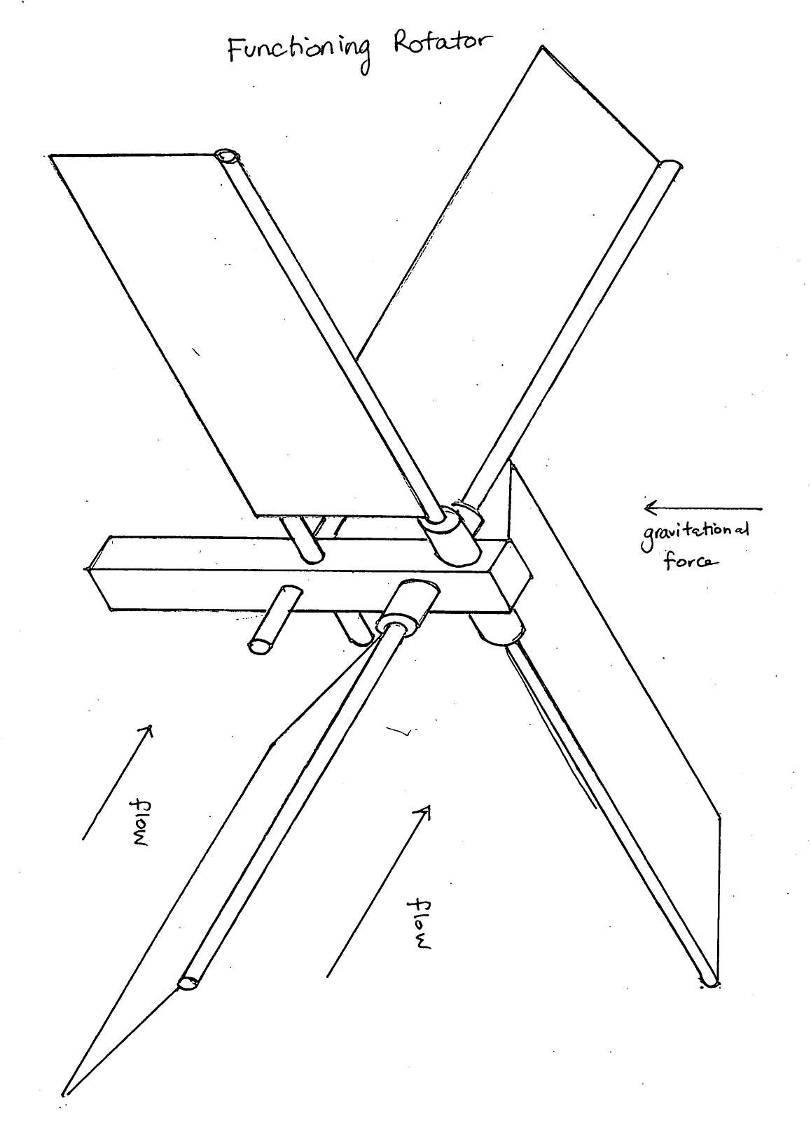

The Flux Rotator (Australian Commonwealth Patent 2002100575). introduces the idea that the vane be hinged on a horizontal axis, and relies on the force of the wind to flip it out of the way on the up wind leg of its circular journey, and a stop (FIG. 3/4) to keep it vertical on the down wind leg.

Following the invention of the Flux Rotator is the Coupled Flux Rotator with a mechanism to synchronize the closing (falling) of the down wind vane and the opening (rising) of the upwind vane. This is achieved with placing both vanes on a common horizontal shaft and having the shaft held in bearings instead of hinged vanes.

I present here a design for a Coupled Vertical Axis, Four Vane, Flux Rotator designed to rotate in a fluid (liquid or gas) flow or a mass/energy flux (Baryons, Hadrons, Leptons or photons).

The design consists of a vertical shaft, terminated at the top end with an arrangement like that in diagram 1/4, being two skew cylindrical holes drilled through the shaft at right angles with respect to their axes. At the termination of each hole is a bearing housing to accommodate a cylindrical horizontal shaft of diameter equal to the inside diameter of the bearing. (These bearings may be roller, ball, plain or any anti-friction type).

The bearings are to accommodate the shaft of the part pictured on diagram 2/4, being a shaft with two planar vanes at either end, the axis of the shaft co-planar to the vanes, but both vanes placed 90 degrees apart about the shaft.

The assembled device is seen in its stationary form in diagram 3/4, with a horizontal shaft as described above through both holes. Notice on the vertical shaft the stops protruding at right angles from four sides of the vertical shaft, at a distance not more than the width of the vanes from the bearing housing.

The functioning device is seen in diagram 4/4. When a flow (shown) impacts on the foremost vane whose normal is co-planar to the flow lines, it causes said (leftmost here) vane to recoil on to the stop, simultaneously rotating the rightmost vane to rotate back and up, no longer impeding the flow. The force on the leftmost vane then exerts a torque about the vertical axis, causing it to rotate about 90 degrees where the second pair of vanes repeats the process.

The formula for the torque is given by
T=P×A×L

Where P is the force per unit area (the pressure), A is the area of the vane and L the length.

This design is able to be manufactured from wood, plastic, metal or composite material and can be built to provide any required torque (subject to cost of materials).

### BRIEF DESCRIPTION OF DRAWINGS

Page 1/4 shows the top end of the vertical shaft, with two skew horizontal lines, drilled at right angles to the shaft. At either end of both holes there is a bearing in a bearing housing to accommodate a horizontal shaft.

Page 2/4 shows one of the horizontal shafts, of either wood, metal, plastic or composite material. At either end of the shaft is a vane, separated by 90 degrees about the shaft-axis. These vanes may be of rigid plywood, laminated fibreglass, or flat, light rigid material.

Page 3/4 shows the assembled, stationary rotator. Notice the stops protruding from the shaft at a distance no more than the width of the vane from the bearing housing.

Page 4/4 shows the functioning rotator. The vanes hang down, the shaft is co-incident to the gradient of the gravitational field, and is at right angles to a flow of fluid.

### SUMMARY OF INVENTION

The Coupled flux rotator is vertical axis omni-directional wind or fluid turbine that has no cables, cams, or linkages, that is free of drag on the upwind journey, more powerful, simpler, cheaper, than any previous design.

1. It is claimed that the flux rotator concept, a vertical-axis wind/fluid turbine having a vane hinged to swing about an axis parallel to a horizontal arm, with a stop, or means to prevent it going about in one direction, forming a kind of one way valve, opened by fluid pressure on its up wind journey and closed by gravity and fluid pressure on its downwind journey, is a novel, simple effective device.

2. It is claimed that in such a vertical axis device the flux rotator is the first device to use fluid pressure on the upwind leg to open the vane, and fluid pressure and gravity to close the one-piece vane. All previous attempts have either used non-rigid vanes, collapsing fabric sails, or have had the vane swinging on a vertical axis, or have opened and closed a complex vane system with a variety of mechanical linkages. All the devices the author has seen would function in a fluid flow in the absence of gravity. The flux rotator would not. Neither at any point is the function of the rotator dependent on centrifugal force as part of its function.

3. It is claimed that the flux rotator concept is independent of the scale. The size of the device may be varied from the dimensions shown and the rotator concept is the same.

4. It is claimed that he vane geometry may be varied to make the vanes curved to some degree and the flux rotator concept is the same.

5. It is claimed that the coupled flux rotator inherits all the unique attributes of the simple flux rotator in the previous claims. Furthermore I claim that its coupled function, the horizontal shaft and the vanes distributed at 90 deg about it is a further, new and inventive step.
